(19) United States
(12) Patent Application Publication
(10) Pub. No.: US 2026/0211414 A1
(43) Pub. Date: Jul. 23, 2026

(54) MOVING BODY REMOTE OPERATION SYSTEM, MOVING BODY REMOTE OPERATION APPARATUS, AND MOVING BODY CONTROL APPARATUS

(71) Applicant: Mitsubishi Electric Corporation, Tokyo (JP)

(72) Inventors: Shota KAMEOKA, Tokyo (JP); Masaya SAKAI, Tokyo (JP); Kenta TOMINAGA, Tokyo (JP); Shogo HARADA, Tokyo (JP)

(73) Assignee: Mitsubishi Electric Corporation, Tokyo (JP)

(21) Appl. No.: 19/139,386

(22) PCT Filed: Mar. 16, 2023
(86) PCT No.: PCT/JP2023/010268

§ 371 Date: Jun. 16, 2025

(51) Int. Cl. G05D 1/222

(52) U.S. Cl. CPC G05D 1/222

(57) ABSTRACT

An object of the present disclosure is to provide a moving body remote operation system, a moving body remote operation apparatus, and a moving body control apparatus capable of operating a plurality of moving bodies performing motions in different movement models. A moving body remote operation system according to the present disclosure includes: an operation amount acquisition unit acquiring an operation amount from an operation apparatus operated by an operator; a setting unit setting an operation target in a plurality of moving bodies performing motions in different movement models; and a control amount calculation unit calculating a control amount of controlling the operation target set by the setting unit based on the operation amount acquired by the operation amount acquisition unit.

### TECHNICAL FIELD

The present disclosure relates to a moving body remote operation system, a moving body remote operation apparatus, and a moving body control apparatus operating a plurality of moving bodies in a remote location.

### BACKGROUND ART

Recently, development of a moving body remote operation system in which an operator can operate a moving body in a remote location proceeds in accordance with growth of a communication technique such as Internet. Developed particularly is a moving body remote operation system achieving labor-saving by making one operator monitor and operate a plurality of moving bodies (for example, refer to Patent Document 1).

### PRIOR ART DOCUMENTS

### Patent Document(s)

Patent Document 1: Japanese Patent No. 6319507

### SUMMARY

### Problem to be Solved by the Invention

When a moving body is operated in various situations, considered is a method of increasing a movement mechanism included in a single moving body and switching the movement mechanism in accordance with the situations, for example. However, such a method leads to increase of cost of the single moving body. It is desired accordingly that a plurality of moving bodies performing motions in different movement models are disposed in accordance with situations, and are operated.

In Patent Document 1, a plurality of automobiles performing a motion in the same movement model are operated. Thus, a plurality of moving bodies performing motions in different movement models cannot be operated.

The present disclosure therefore has been made to solve such problems, and it is an object to provide a moving body remote operation system, a moving body remote operation apparatus, and a moving body control apparatus capable of operating a plurality of moving bodies performing motions in different movement models.

### Means to Solve the Problem

In order to solve the above problems, a moving body remote operation system according to the present disclosure includes: an operation amount acquisition unit acquiring an operation amount from an operation apparatus operated by an operator; a setting unit setting an operation target in a plurality of moving bodies performing motions in different movement models; and a control amount calculation unit calculating a control amount of controlling the operation target set by the setting unit based on the operation amount acquired by the operation amount acquisition unit.

### Effects of the Invention

According to the present disclosure, the plurality of moving bodies performing motions in the different movement models can be operated.

These and other objects, features, aspects and advantages of the present disclosure will become more apparent from the following detailed description when taken in conjunction with the accompanying diagrams.

### BRIEF DESCRIPTION OF DRAWINGS

FIG. 1 is a block diagram illustrating an example of a configuration of a moving body remote operation system according to an embodiment 1.

FIG. 2 is a diagram for explaining a moving body according to the embodiment 1.

FIG. 3 is a diagram for explaining the moving body according to the embodiment

FIG. 4 is a block diagram illustrating an example of a configuration of a moving body remote operation apparatus according to the embodiment 1.

FIG. 5 is a block diagram illustrating an example of a configuration of a moving body control apparatus and the moving body according to the embodiment 1.

FIG. 6 is a diagram illustrating an example of a combination of a motion mode, an operation mechanism, and a moving body according to the embodiment 1.

FIG. 7 is a diagram for explaining an automobile mode according to the embodiment 1,

FIG. 8 is a diagram illustrating an example of a movement of differential two wheels in the automobile mode according to the embodiment 1.

FIG. 9 is a diagram for explaining a flexible mode according to the embodiment 1.

FIG. 10 is a diagram illustrating an example of a movement of an automobile in the flexible mode according to the embodiment 1.

FIG. 11 is a diagram for explaining a touch panel mode according to the embodiment 1.

FIG. 12 is a diagram illustrating an example of a movement of an automobile in the touch panel mode according to the embodiment 1.

FIG. 13 is a diagram illustrating an example of a movement model of an automobile according to the embodiment 1.

FIG. 14 is a diagram illustrating an example of a configuration of a control amount calculation unit according to the embodiment 1.

FIG. 15 is a diagram illustrating an example of a configuration of the control amount calculation unit according to the embodiment 1.

FIG. 16 is a diagram illustrating an example of a configuration of the control amount calculation unit according to the embodiment 1.

FIG. 17 is a flow chart illustrating an example of a motion of the moving body remote operation apparatus according to the embodiment 1.

FIG. 18 is a flow chart illustrating an example of a motion of the moving body remote operation apparatus according to the embodiment 1.

FIG. 19 is a flow chart illustrating an example of a motion of the moving body control apparatus according to the embodiment 1.

FIG. 20 is a flow chart illustrating an example of a motion of the moving body control apparatus according to the embodiment 1.

FIG. 21 is a block diagram illustrating an example of a configuration of a moving body remote operation apparatus according to an embodiment 2.

FIG. 22 is a block diagram illustrating an example of a configuration of a moving body control apparatus according to the embodiment 2.

FIG. 23 is a block diagram illustrating an example of a hardware configuration of the moving body remote operation apparatus according to the embodiments 1 and 2.

FIG. 24 is a block diagram illustrating an example of a hardware configuration of the moving body remote operation apparatus according to the embodiments 1 and 2.

### DESCRIPTION OF EMBODIMENT(S)

### Embodiment 1

### <Configuration of Moving Body Remote Operation System>

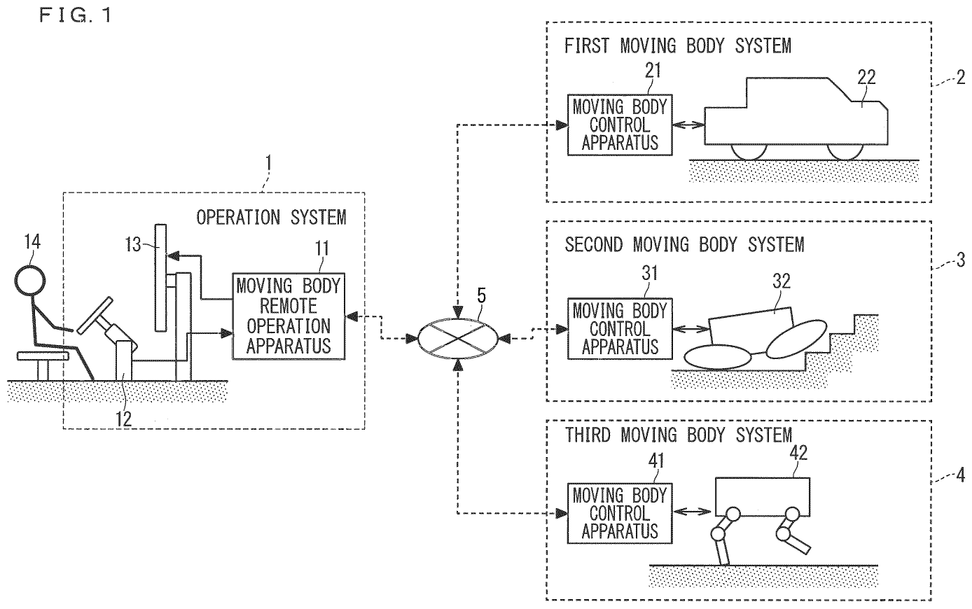

FIG. 1 is a block diagram illustrating an example of a configuration of a moving body remote operation system according to an embodiment 1. The moving body remote operation system includes an operation system 1, a first moving body system 2, a second moving body system 3, a third moving body system 4, and a network 5. The operation system 1 is communicably connected to each of the first moving body system 2, the second moving body system 3, and the third moving body system 4 via the network 5. A first moving body 22, a second moving body 32, and a third moving body 42 perform motions in movement models different from each other.

FIG. 1 exemplifies three moving body systems (the first moving body system 2, the second moving body system 3, and the third moving body system 4). However, the number of the moving body systems may be two or four or more. A moving body other than the first moving body 22, the second moving body 32, and the third moving body 42 may be an operation target. In a case of FIG. 1, three moving bodies performing motions in three types of movement models are to be operated. However, the configuration is not limited thereto. Three (two or four or more) moving bodies performing motions in at least two types of movement models may be operation targets. That is to say, the first moving body 22 and the second moving body 32 performing motions in the same movement model and the third moving body 42 performing motions in the movement model different from the first moving body 22 and the second moving body 32 may be operation targets.

The operation system 1 includes a moving body remote operation apparatus 11, an operation apparatus 12, and an image display 13. An operator 14 sees an image displayed on the image display 13, and operates the operation apparatus 12 to operate a moving body (any one of the first moving body 22, the second moving body 32, and the third moving body 42) as an operation target. The moving body remote operation apparatus 11 transmits an amount of movement (operation amount) at a time when the operator 14 operates the operation apparatus 12 to operate the moving body to the moving body control apparatus (any one of moving body control apparatuses 21, 31, and 41) controlling the motion of the moving body as the operation target. The moving body remote operation apparatus 11 receives information of a camera and a sensor provided to the moving body from the moving body control apparatus controlling the motion of the moving body as the operation target, and generates an image displayed on the image display 13 based on the information.

The first moving body system 2 includes of the moving body control apparatus 21 and the first moving body 22. The moving body control apparatus 21 controls the motion of the first moving body 22 based on the operation amount received from the moving body remote operation apparatus 11. The moving body control apparatus 21 transmits the information of the camera and the sensor provided to the first moving body 22 to the moving body remote operation apparatus 11. The first moving body 22 is a moving body such as an automobile including vehicle wheels as a movement mechanism, for example.

The second moving body system 3 includes the moving body control apparatus 31 and the second moving body 32. A configuration and a motion of the moving body control apparatus 31 are similar to those of the moving body control apparatus 21. The second moving body 32 is a moving body such as a crawler including a crawler mechanism as a movement mechanism, for example.

The third moving body system 4 includes the moving body control apparatus 41 and the third moving body 42. A configuration and a motion of the moving body control apparatus 41 are similar to those of the moving body control apparatus 21. The third moving body 42 is a moving body such a legged robot including a leg as a movement mechanism, for example.

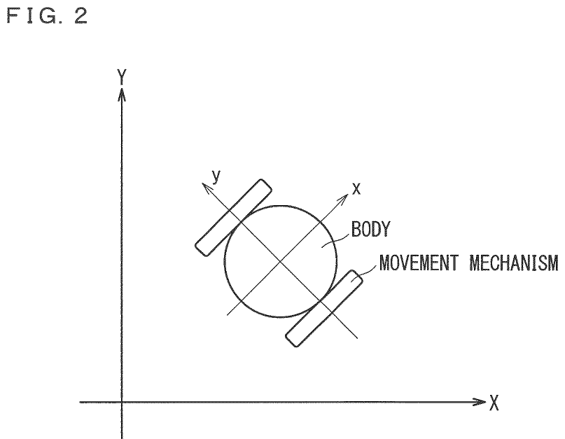

FIG. 2 is a diagram for explaining the moving body according to the embodiment 1. The moving body is an object which can change a position and a posture of a body coordinate system of the moving body itself with respect to a reference coordinate system by a movement mechanism included in the moving body itself. In FIG. 2, an XY coordinate system is the reference coordinate system, and an xy coordinate system is the body coordinate system. FIG. 2 exemplifies a moving body having differential two wheels as a movement mechanism.

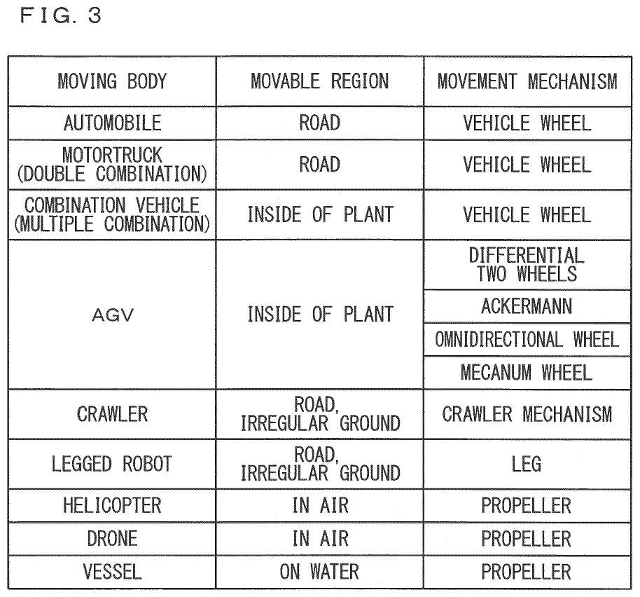

As exemplified in FIG. 3, a region in which the moving body can be moved is different depending on a movement mechanism included in the moving body itself. Each moving body illustrated in FIG. 3 has a different movement model (a type of operation and a type of movement) when the movement mechanism is different from each other. For example, in an automobile, a position and a posture of the automobile can be operated by an operation of a steering, an operation of an accelerator pedal, and an operation of a brake pedal. This can be “the movement model” of the automobile.

The moving body is not limited to an existing moving body, but may be a moving body in a virtual space (simulation space). The virtual space may be a driving simulator, for example. The moving body in the virtual space corresponds to a calculator (server) into which a physical simulator is incorporated, for example. In this case, an image corresponding to a viewpoint of the moving body in the physical simulator is displayed on the image display 13. Accordingly, the operator can acquaint himself/herself with an operation of each moving body in the virtual space.

### <Configuration of Moving Body Remote Operation Apparatus>

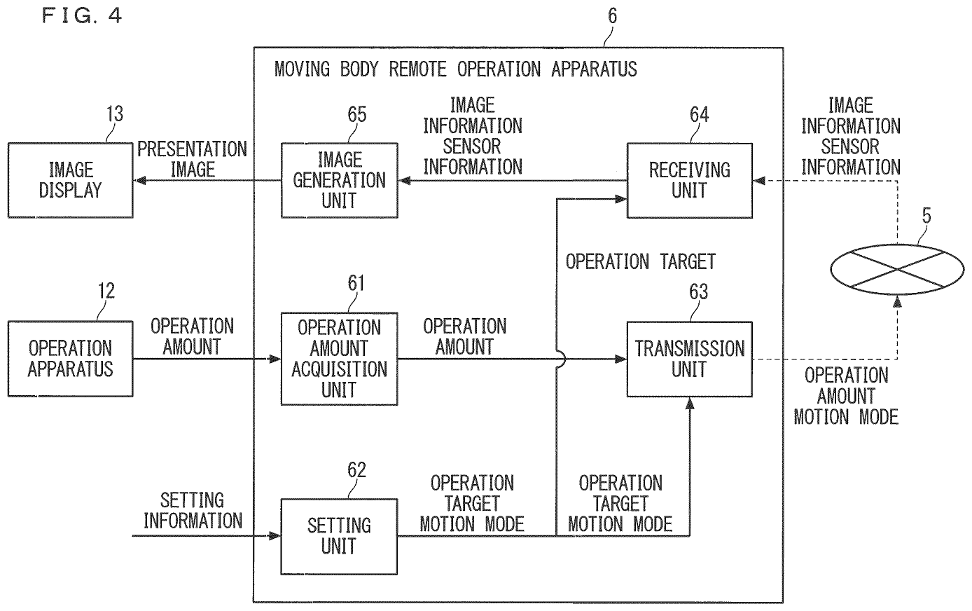

FIG. 4 is a block diagram illustrating an example of a configuration of a moving body remote operation apparatus 6 according to the embodiment 1. The moving body remote operation apparatus 6 includes an operation amount acquisition unit 61, a setting unit 62, a transmission unit 63, a receiving unit 64, and an image generation unit 65. The moving body remote operation apparatus 6 is connected to the operation apparatus 12 and the image display apparatus 13. The moving body remote operation apparatus 6 corresponds to the moving body remote operation apparatus 11 illustrated in FIG. 1.

The operation apparatus 12 includes an operation mechanism such as “steering, accelerator pedal, and brake pedal”, “joystick”, “mouse and keyboard”, or “tablet”, for example. The operation apparatus 12 may include one or the plurality of these operation mechanisms. When the operation apparatus 12 includes the plurality of operation mechanisms, the operator 14 (refer to FIG. 1, the same applies to the following) actually operates one of those operation mechanisms.

The image display 13 is a display or a head-mounted display, for example.

The operation amount acquisition unit 61 acquires the operation amount from the operation apparatus 12 operated by the operator 14. Specifically, the operation amount acquisition unit 61 decodes the operation amount acquired from the operation apparatus 12.

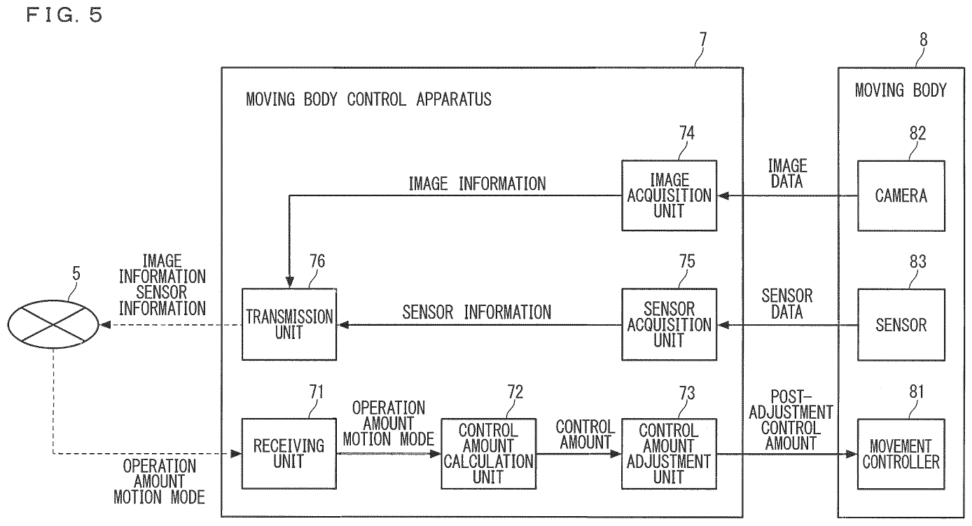

The setting unit 62 sets an operation target and a motion mode based on setting information designated by the operator 14. The operation target is a moving body (a moving body 8 in FIG. 5 described hereinafter) designated by the operator 14 in the plurality of moving body performing motions in the different movement models. A plurality of operation targets are also applicable. The motion mode is the movement model making the operation target designated by the operator 14 perform a motion. Details of the motion mode are described hereinafter. The operator 14 may designate the setting information using the operation apparatus 12. The setting unit 62 may automatically select the motion mode when the operation target designated by the operator 14 is set.

The transmission unit 63 transmits the operation amount acquired by the operation amount acquisition unit 61 and the motion mode set by the setting unit 62 to a moving body control apparatus (a moving body control apparatus 7 in FIG. 5 described hereinafter) controlling the operation target set by the setting unit 62 via the network 5. The transmission unit 63 has a function of switching the moving body control apparatus as a transmission destination (communication partner) of the operation amount and the motion mode based on the operation target set by the setting unit 62. When the operation target includes the plurality of moving bodies, the transmission unit 63 may collectively transmit information to the moving body control apparatus controlling these moving bodies. In this case, these moving bodies perform the same motion in accordance with the operation of the operator 14.

The receiving unit 64 receives image information and sensor information around the operation target (a moving body 8 in FIG. 5 described hereinafter) from the moving body control apparatus (the moving body control apparatus 7 in FIG. 5 described hereinafter) via the network. The receiving unit 64 has a function of switching the moving body control apparatus as a transmission destination (communication partner) of the image information and the sensor information based on the operation target set by the setting unit 62.

The image generation unit 65 performs image processing based on the image information and the sensor information received by the receiving unit 64, and generates a presentation image presented to the operator.

The image generation unit 65 may correct a field angle and a size of the presentation image so that a viewpoint corresponding to a movement of each moving body 8 is unified. Accordingly, a difference of vision for each moving body 8 can be reduced. For example, when the operator 14 performs an operation of rotating the operation target, the image generation unit 65 corrects the presentation image so that the operation target is rotated in place by changing the viewpoint in accordance with the movement of the operation target.

The image generation unit 65 may correct distortion of the presentation image by a rolling movement, a pitch movement, and an up-down movement of the moving body 8 (for example, the legged robot).

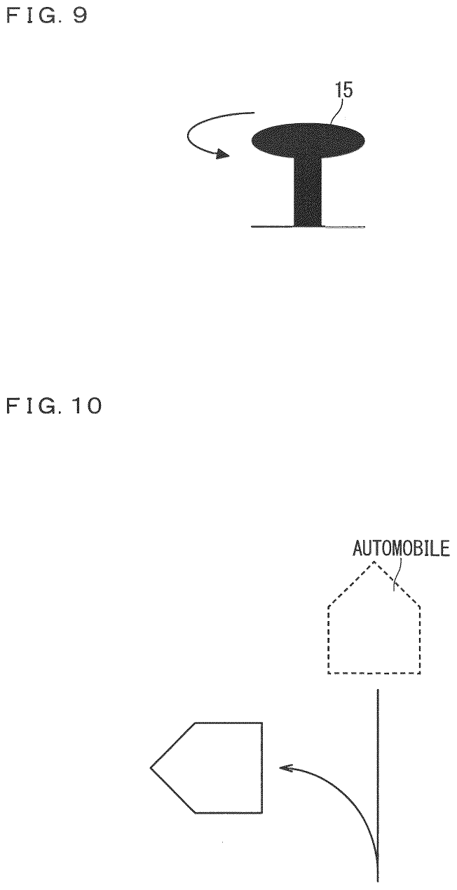

The image generation unit 65 corrects the presentation image to prevent a time delay in accordance with control of the operation target. “The time delay in accordance with control of the moving body” herein includes not only a delay due to an automobile which cannot be rotated at the position with respect to a rotational operation of a joystick 15 as illustrated in FIGS. 9 and 10 described above but also a communication delay between the moving body remote operation apparatus 6 and the moving body control device 7.

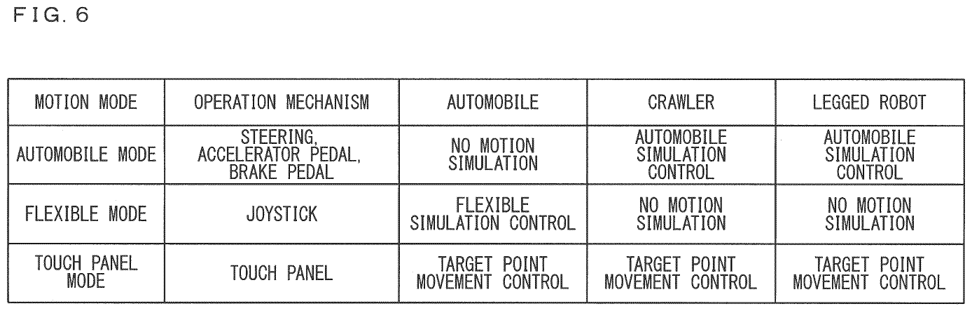

The image generation unit 65 may generate a presentation image including a control amount calculated by a control amount calculation unit 72 (refer to FIG. 5 described hereinafter). In this case, the receiving unit 64 receives the control amount calculated by the control amount calculation unit 72 from the moving body control apparatus 7 (refer to FIG. 5 described hereinafter). For example, when an automobile is rotated in place while the motion mode is set to the flexible mode (refer to FIG. 6, details are described hereinafter), rotatable angle and time are changed depending on presence or absence of an obstacle around the automobile. Thus, such information is included in the presentation image, and is presented to the operator 14.

When the movement model corresponding to a motion of the operation of the operation apparatus 12 and the movement model of the moving body 8 as the operation target are different from each other, the image generation unit 65 generates the presentation image including an image simulating the other operation apparatus (the operation apparatus other than the operation apparatus 12) corresponding to the movement model of the moving body 8 as the operation target. In this case, the operation amount acquisition unit 61 converts the operation amount acquired from the operation apparatus 12 into an operation amount in the other operation apparatus, and outputs the converted operation amount to the image generation unit 65. For example, in a case where the operation mechanism of the operation apparatus 12 is a steering, an accelerator pedal, and a brake pedal, when the operation target is switched to a four-legged robot, the image display 13 displays a presentation image including an image (an image of a joystick moved in accordance with operations of the steering, the accelerator pedal, and the brake pedal) as if the operation target were operated by a joystick (an operation apparatus corresponding to the movement model of the four-legged robot). In this case, the operation amount acquisition unit 61 converts the operation amount of each of the steering, the accelerator pedal, and the brake pedal into the operation amount in a case of operating the joystick. Specifically, for example, the operation amount of the rotational operation of the steering is converted into the operation amount of an inclination operation of the joystick on right and left sides, and the operation amount of the operation of the accelerator pedal and the brake pedal is converted into the operation amount of an inclination operation of the joystick on front and back sides. At this time, the operation amount acquisition unit 61 acquires the motion mode set by the setting unit 62. The processing of converting the operation amount may be executed by the control amount calculation unit 72 of the moving body control apparatus 7 in place of the operation amount acquisition unit 61.

### <Configuration of Moving Body Control Apparatus and Moving Body>

FIG. 5 is a block diagram illustrating an example of a configuration of the moving body control apparatus 7 and the moving body 8 according to the embodiment 1. The moving body control apparatus 7 is an apparatus controlling the moving body 8, and is communicably connected to the moving body 8. The moving body control apparatus 7 corresponds to any of the moving body control apparatuses 21, 31, and 41 illustrated in FIG. 1. The moving body 8 corresponds to any of the first moving body 22, the second moving body 32, and the third moving body 42 illustrated in FIG. 1, and is the operation target designated by the operator 14.

The moving body control apparatus 7 includes a receiving unit 71, a control amount calculation unit 72, a control amount adjustment unit 73, an image acquisition unit 74, a sensor acquisition unit 75, and a transmission unit 76.

The receiving unit 71 receives the operation amount and the motion mode transmitted from the moving body remote operation apparatus 6 via the network 5.

The control amount calculation unit 72 calculates the calculation amount of controlling the moving body 8 based on the operation amount and the motion mode received by the receiving unit 71. Specifically, the control amount calculation unit 72 calculates the control amount based on the operation amount to make the moving body 8 simulate the motion corresponding to the motion mode designated by the operator 14. Details of the processing of the control amount calculation unit 72 are described hereinafter.

The control amount adjustment unit 73 adjusts the control amount calculated by the control amount calculation unit 72 in accordance with a scale of the operation target. The control amount adjustment unit 73 outputs the control amount after adjustment (post-adjustment control amount) to the moving body 8. The control amount adjustment unit 73 may be integrally formed with the control amount calculation unit 72. In this case, the control amount calculation unit 72 has a function of the control amount adjustment unit 73, and the control amount adjustment unit 73 illustrated in FIG. 5 is omitted. Herein, the scale is basically a representative length of the moving body, and is a whole length in an automobile, for example. Mass or inertia moment may be the scale in place of the whole length. The control amount adjustment unit 73 adjusts the control amount so that a speed is reduced in proportion to the scale even when the operation amount received by the receiving unit 71 is the same as each other as an example. Furthermore, the control amount adjustment unit 73 may appropriately adjust the scale in which the operator 14 can easily perform operation in accordance with the moving body.

The image acquisition unit 74 acquires image data of an image taken by a camera 82 provided to the moving body 8 as image information around the moving body 8. The sensor acquisition unit 75 acquires sensor data detected by a sensor 83 provided to the moving body 8 as sensor information around the moving body 8. The transmission unit 76 transmits the image information acquired by the image acquisition unit 74 and the sensor information acquired by the sensor acquisition unit 75 to the moving body remote operation apparatus 6 via the network 5.

The moving body 8 includes a movement controller 81, the camera 82, and the sensor 83. When the moving body 8 is located in a virtual space, the camera 82 and the sensor 83 are numerically calculated in the virtual space.

The movement controller 81 controls an actuator (not shown) making the moving body 8 perform the motion based on the post-adjustment control amount acquired from the moving body control apparatus 7.

The camera 82 takes an image of an environment around the moving body 8, and outputs the taken image data to the moving body control apparatus 7. Examples of the camera 82 include a monochrome camera, a color camera, an infrared camera, a stereo camera, a light detection and ranging (LIDAR). Any camera is applicable to the camera 82 as long as it outputs image information enabling the operator 14 to recognize the environment around the moving body 8. When the camera 82 significantly vibrates in accordance with the movement of the moving body 8 and the vibration interferes with the operation of the operator 14, the camera 82 may be disposed on a vibration suppression apparatus such as a gimbal stabilizer, for example.

The senor 83 detects information regarding the movement of the moving body 8 such as an acceleration rate and a speed of the moving body 8, and outputs sensor data as a detection result to the moving body control apparatus 7.

### <Motion Mode>

The operator 14 can designate the movement model in which the operator 14 would like the moving body 8 to perform the motion. The movement model designated by the operator 14 is referred to as “the motion mode”. For example, when the operation mechanism of the operation apparatus 12 includes a steering, an accelerator pedal, and a brake pedal, and the operation target is switched from an automobile to a crawler, the operator 14 feels strangeness by reason that the movement model is different between the automobile and the crawler (as illustrated in FIG. 3, since the automobile and the crawler have the movement mechanism different from each other, the movement model is also different). In this case, the strangeness felt by the operator 14 can be reduced by making the crawler simulate the motion of the automobile. In this manner, even when the movement model is different before and after switching the operation target, it is sufficient that the operation target is controlled so that the difference is reduced as much as possible.

FIG. 6 is a diagram illustrating an example of a combination of the motion mode, the operation mechanism, and the moving body according to the embodiment 1. The motion mode includes the automobile mode, the flexible mode, and the touch panel mode, but is not limited thereto. The moving body includes the automobile, the crawler, and the legged robot, but is not limited thereto.

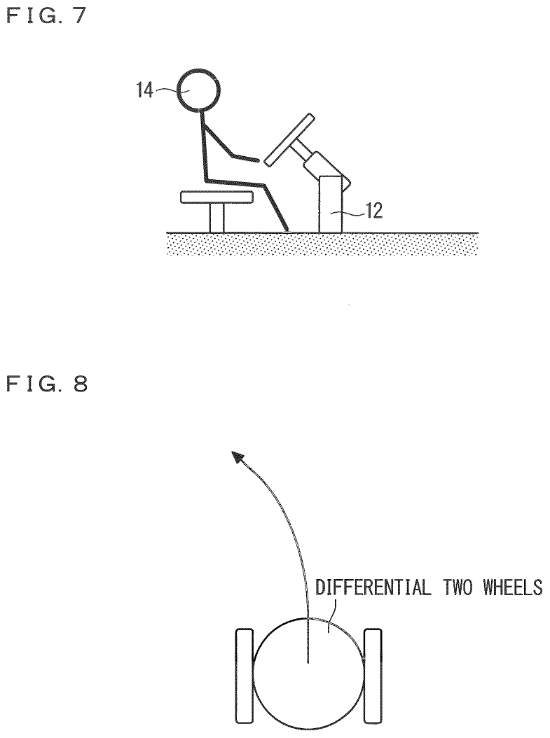

The automobile mode is the motion mode corresponding to a case where the operation mechanism of the operation apparatus 12 is the steering, the accelerator pedal, and the brake pedal (refer to FIG. 7). In the automobile mode, in a case where the moving body (the crawler and the legged robot in the example in FIG. 6) other than the automobile is the operation target, the operation target is made to simulate the motion of the automobile (automobile simulation control). For example, the moving body having differential two wheels as the movement mechanism illustrated in FIG. 8 is made to simulate the motion of the automobile. Accordingly, strangeness felt by the operator 14 can be reduced. When the automobile is the operation target, there is no need to make the automobile simulate the motion of the automobile. It may be determined whether or not the operation target is made to simulate the motion by making the moving body control apparatus 7 have the motion mode (the automobile mode, the flexible mode, or the touch panel mode) corresponding to the moving body 8 and comparing the motion mode with the motion mode (the automobile mode, the flexible mode, or the touch panel mode) received from the moving body remote operation apparatus 6, for example.

The flexible mode is the motion mode corresponding to a case where the operation mechanism of the operation apparatus 12 is the joystick 15 (refer to FIG. 9). In the flexible mode, in a case where a moving body (the automobile in the example in FIG. 6) which cannot be rotated in place is the operation target, the operation target is made to simulate the motion of being flexibly rotated (flexible simulation control). For example, the automobile illustrated in FIG. 10 is made to simulate the motion of being flexibly rotated. Accordingly, strangeness felt by the operator 14 can be reduced. When the crawler and the legged robot are the operation targets, there is no need to make them simulate the motion of being flexibly rotated.

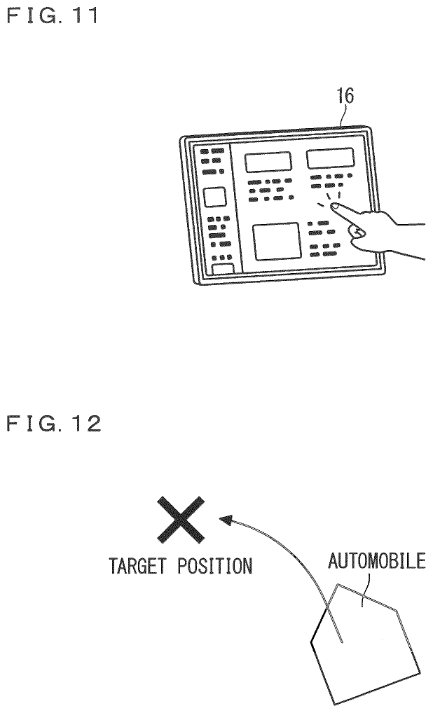

The touch panel mode is the motion mode corresponding to a case where the operation mechanism of the operation apparatus 12 is the touch panel 16 (refer to FIG. 11). In the touch panel mode, the operator 14 touches an image (an image taken by the camera provided to the moving body) displayed on the touch panel 16 to designate a target movement point, thereby moving the moving body to the target movement point (target point movement control). For example, the automobile illustrated in FIG. 12 is moved to a target position (the target movement point). Accordingly, strangeness felt by the operator 14 can be reduced.

### <Processing of Control Amount Calculation Unit 72>

A target angular speed, a target acceleration rate, and a target speed (these are referred to as “the control amount”) with respect to a body coordinate system of the moving body need to be set to move the moving body. Accordingly, when the control amount calculation unit 72 calculates the control amount based on the motion mode and the operation amount, various moving bodies can be made to simulate the motion designated by the operator 14.

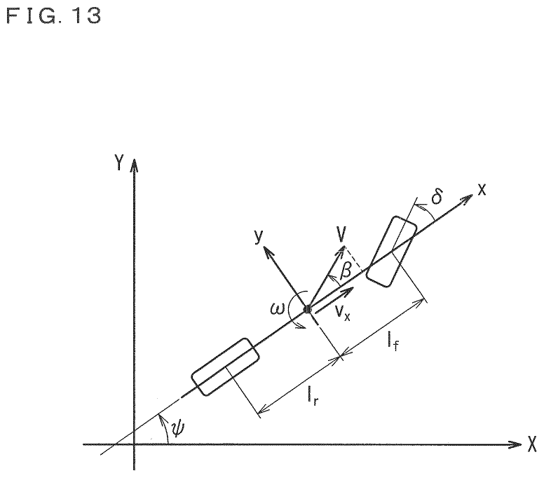

Normally, the moving object includes the movement model indicating the movement of the moving body and a state equation specifically expressing the movement model in a mathematical expression. For example, the automobile includes a two-wheel model as the movement model (refer to FIG. 13) and a state equation based on the two-wheel model. In FIG. 13, δ is a rudder angle, V is a speed, vx is a speed in an x-axis direction, ψ is an orientation, If is a distance from a center of gravity to front wheels, lr is a distance from a center of gravity to rear wheels, ω is an angular speed, XY is a reference coordinate system, and xy is a body coordinate system. Since the state equation expresses the motion of the movement of the moving body, the control amount can be calculated from the state equation.

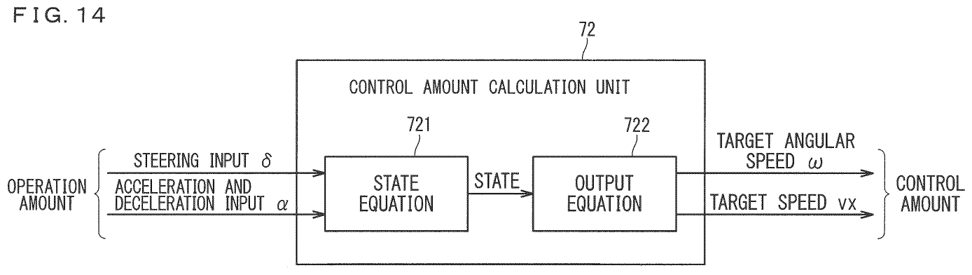

FIG. 14 is a diagram illustrating an example of a configuration of the control amount calculation unit 72 in a case where the motion mode is the automobile mode. In the automobile mode, the control amount calculation unit 72 executes each function of a state equation 721 and an output equation 722.

Specifically, the state equation 721 is dx/dt=f(x, u). Herein, x is a state, and u is a control input. The output equation 722 for taking out the control amount from the state equation 721 is y=h(x, u). In the automobile mode, the state equation 721 and the output equation 722 are Expressions (1) to (4) described hereinafter, for example. A state x is calculated by integrating the state equation 721. In Expression (3), Cf is cornering stiffness of front wheels, Cr is cornering stiffness of rear wheels, m is mass, and I is inertia moment.

$$\begin{matrix}[ Expression 1 ] & \\ x = {[ \begin{matrix}\begin{matrix}β & ω\end{matrix} & {v}_{x}\end{matrix} ]}^{T} & ( 1 )\end{matrix}$$

$$\begin{matrix}[ Expression 2 ] & \\ u = {[ \begin{matrix}δ & α\end{matrix} ]}^{T} & ( 2 )\end{matrix}$$

$$\begin{matrix}[ Expression 3 ] & \\ \frac{dx}{dt} = f ( x , u ) = [ \begin{matrix}- \frac{2 ( {C}_{f} + {C}_{r} )}{{mv}_{x}} β + ( - 1 - \frac{2 ( {l}_{f} {C}_{f} - {l}_{r} {C}_{r} )}{{mv}_{x}^{2}} ) ω \\ - \frac{2 ( {l}_{f} {C}_{f} - {l}_{r} {C}_{r} )}{I} β - \frac{2 ( {l}_{f}^{2} {C}_{f} + {l}_{r}^{2} {C}_{r} )}{{Iv}_{x}} ω \\ 0\end{matrix} ] + [ \begin{matrix}\frac{2 {C}_{f}}{{mv}_{x}} & 0 \\ \frac{2 {l}_{f} {C}_{f}}{I} & 0 \\ 0 & 1\end{matrix} ] [ \begin{matrix}δ \\ α\end{matrix} ] & ( 3 )\end{matrix}$$

$$\begin{matrix}[ Expression 4 ] & \\ γ = h ( x , u ) = [ \begin{matrix}ω \\ {v}_{x}\end{matrix} ] & ( 4 )\end{matrix}$$

When the target angular speed ω and the target speed vx obtained from the state equation 721 and the output equation 722 are set to the control amount, the operation target can be made to simulate the motion of the automobile.

The state equation 721 and the output equation 722 may be set in accordance with the moving body whose motion is to be simulated (set based on the motion mode), The moving body whose motion is to be simulated may be a moving body other than the automobile, thus may also be an automobile virtually having small mass. In this case, the motions of the various moving bodies can be simulated,

The state equation 721 for recreating a phenomenon (for example, a creep phenomenon) specific to the automobile may be established.

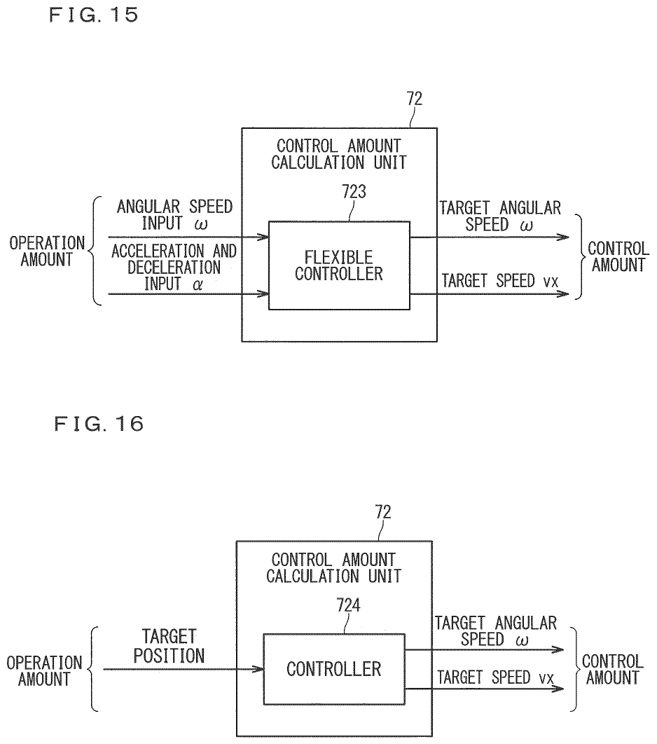

FIG. 15 is a diagram illustrating an example of a configuration of the control amount calculation unit 72 in a case where the motion mode is the flexible mode. In the flexible mode, the control amount calculation unit 72 executes a function of a flexible controller 723.

For example, when the automobile as the operation target is operated in the flexible mode, the flexible controller 723 calculates the control amount (the target angular speed ω and the target speed vx) for the automobile to simulate the motion of being rotated in place.

FIG. 16 is a diagram illustrating an example of a configuration of the control amount calculation unit 72 in a case where the motion mode is the touch panel mode. In the touch panel mode, the control amount calculation unit 72 executes a function of a controller 724.

For example, when the operator 14 designates the target position, the controller 724 calculates the control amount (the target angular speed ω and the target speed vx) of moving the operation target to the target position.

In this manner, the control amount calculation unit 72 has each function of “the state equation 721 and the output equation 722 illustrated in FIG. 14”, “the flexible controller 723 illustrated in FIG. 15”, and “the controller 724 illustrated in FIG. 16”, and executes each function in accordance with the motion mode.

### <Motion>

### <Motion of Moving Body Remote Operation Apparatus 6>

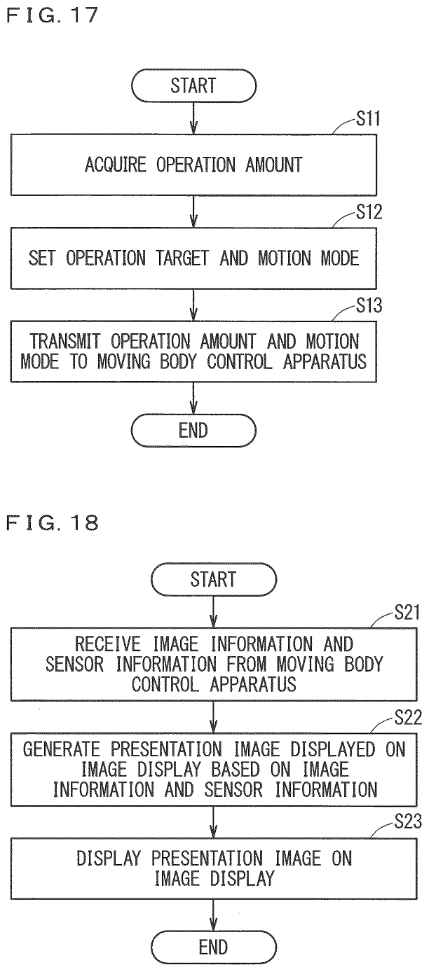

The motion of the moving body remote operation apparatus 6 is broadly divided into a transmission motion (FIG. 17) of transmitting the operation amount and the motion mode to the moving body control apparatus 7 and a receiving operation (FIG. 18) of receiving the image information and the sensor information from the moving body control apparatus 7. These motions are sequentially described hereinafter.

FIG. 17 is a flow chart illustrating an example of the transmission motion of the moving body remote operation apparatus 6 according to the embodiment 1.

In Step S11, the operation amount acquisition unit 61 acquires the operation amount from the operation apparatus 12.

In Step S12, the setting unit 62 sets the operation target and the motion mode based on the setting information designated by the operator 14.

In Step S13, the transmission unit 63 transmits the operation amount acquired by the operation amount acquisition unit 61 and the motion mode set by the setting unit 62 to the moving body control apparatus 7 controlling the operation target (the moving body 8) set by the setting unit 62.

FIG. 18 is a flow chart illustrating an example of the receiving motion of the moving body remote operation apparatus 6 according to the embodiment 1.

In Step S21, the receiving unit 64 receives the image information and the sensor information around the operation target (the moving body 8) from the moving body control apparatus 7.

In Step S22, the image generation unit 65 generates the presentation image presented to the operator based on the image information and the sensor information received by the receiving unit 64.

In Step S23, the presentation image generated by the image generation unit 65 is displayed on the image display 13. At this time, the image display 13 may be controlled so that the image generation unit 65 displays the presentation image.

### <Motion of Moving Body Control Apparatus 7>

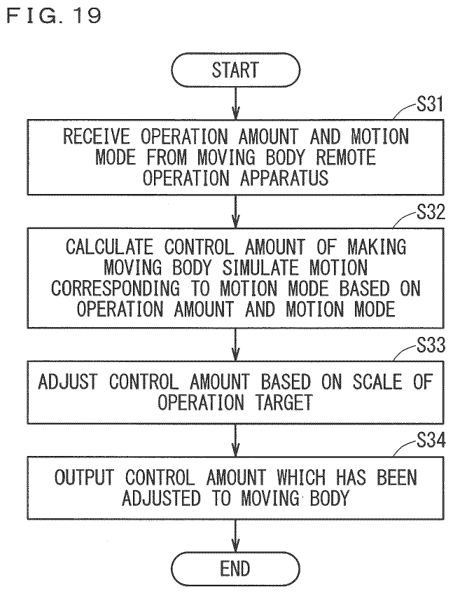

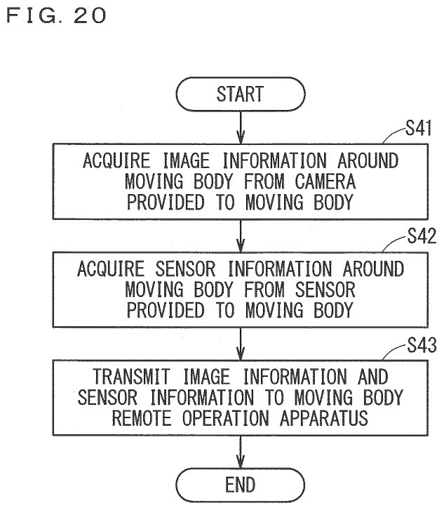

The motion of the moving body control apparatus 7 is broadly divided into a receiving motion (FIG. 19) of receiving the operation amount and the motion mode from the moving body remote operation apparatus 6 and a transmission operation (FIG. 20) of transmitting the image information and the sensor information to the moving body remote operation apparatus 6. These motions are sequentially described hereinafter.

FIG. 19 is a flow chart illustrating an example of the receiving motion of the moving body control apparatus 7 according to the embodiment 1.

In Step S31, the receiving unit 71 receives the operation amount and the motion mode transmitted from the moving body remote operation apparatus 6.

In Step S32, the control amount calculation unit 72 calculates the control amount for making the moving body 8 simulating the motion corresponding to the motion mode based on the operation amount and the motion mode received by the receiving unit 71.

In Step S33, the control amount adjustment unit 73 adjusts the control amount calculated by the control amount calculation unit 72 in accordance with the scale of the operation target.

In Step S34, the control amount adjustment unit 73 outputs the control amount after adjustment to the moving body 8.

FIG. 20 is a flow chart illustrating an example of the transmission motion of the moving body control apparatus 7 according to the embodiment 1.

In Step S41, the image acquisition unit 74 acquires the image information around the moving body 8 from the camera 82 provided to the moving body 8.

In Step S42, the sensor acquisition unit 75 acquires the sensor information around the moving body 8 from the sensor 83 provided to the moving body 8.

In Step S43, the transmission unit 76 transmits the image information acquired by the image acquisition unit 74 and the sensor information acquired by the sensor acquisition unit 75 to the moving body remote operation apparatus 6.

### Effect

The moving body remote operation apparatus 6 transmits the operation amount in which the operator 14 operates the operation apparatus 12 and the motion mode designated by the operator 14 to the moving body control apparatus 7 controlling the operation target designated by the operator 14. The moving body control apparatus 7 calculates the control amount of controlling the motion of the moving body 8 based on the operation amount and the motion mode received from the moving body remote operation apparatus 6, and outputs the control amount to the moving body 8. Accordingly, the operator 14 can operate the plurality of moving bodies performing motions in the different movement models. Even when the operation mechanism of the operation apparatus 12 is not an original operation mechanism of operating the moving body 8, strangeness felt by the operator 14 can be reduced by reason that the moving body 8 performs the motion in the control amount corresponding to the motion mode designated by the operator 14.

### Embodiment 2

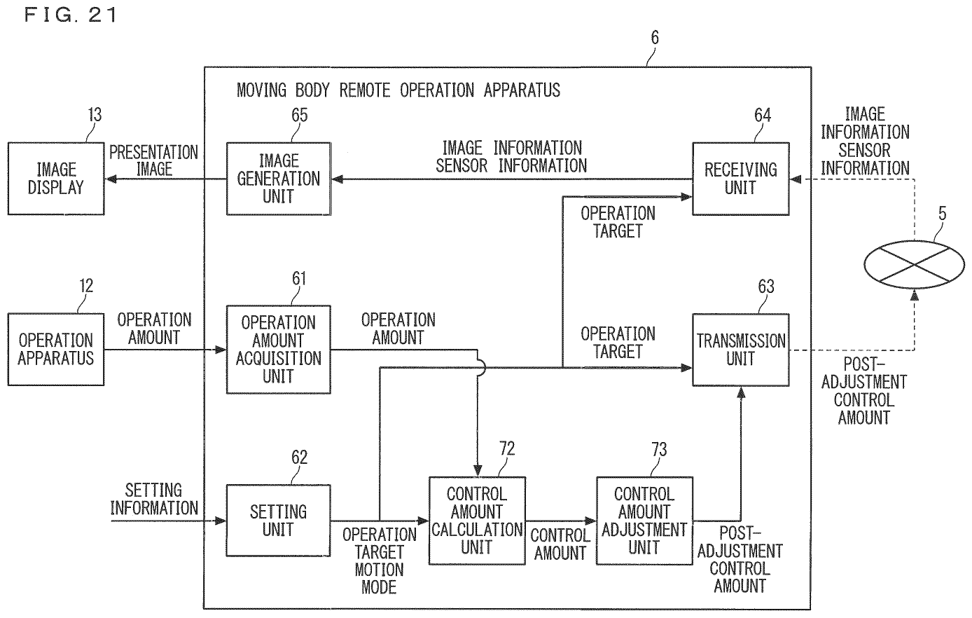

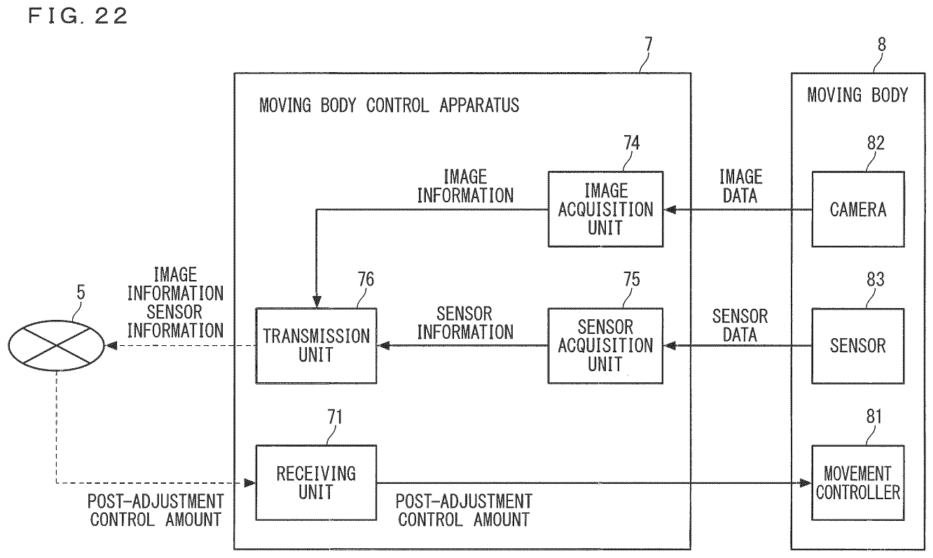

FIG. 21 is a block diagram illustrating an example of a configuration of the moving body remote operation apparatus 6 according to an embodiment 2. FIG. 22 is a block diagram illustrating an example of a configuration of the moving body control apparatus 7 according to the embodiment 2.

As illustrated in FIG. 21, the moving body remote operation apparatus 6 according to the embodiment 2 is different from the moving body remote operation apparatus 6 according to the embodiment 1 (refer to FIG. 4) in that the control amount calculation unit 72 and the control amount adjustment unit 73 of the moving body control apparatus 7 according to the embodiment 1 (refer to FIG. 5) are added. In the moving body remote operation apparatus 6 according to the embodiment 2, the transmission unit 63 transmits the control amount (the post-adjustment control amount) adjusted by the control amount adjustment unit 73 to the moving body control apparatus 7. The other motion is similar to that of the moving body remote operation apparatus 6 according to the embodiment 1.

As illustrated in FIG. 22, the moving body control apparatus 7 according to the embodiment 2 is different from the moving body control apparatus 7 according to the embodiment 1 (refer to FIG. 5) in that the control amount calculation unit 72 and the control amount adjustment unit 73 are omitted. In the moving body control apparatus 7 according to the embodiment 2, the receiving unit 71 receives the post-adjustment control amount transmitted from the moving body remote operation apparatus 6, and outputs the post-adjustment control amount to the moving body 8. The other motion is similar to that of the moving body control apparatus 7 according to the embodiment 1.

As described above, according to the embodiment 2, the configuration of the moving body control apparatus 7 can be simplified.

### Hardware Configuration

Each function of the operation amount acquisition unit 61, the setting unit 62, the transmission unit 63, the receiving unit 64, and the image generation unit 65 in the moving body remote operation apparatus 6 described in the embodiment 1 is achieved by a processing circuit. That is to say, the moving body remote operation apparatus 6 includes a processing circuit for acquiring the operation amount, setting the operation target and the motion mode, transmitting the operation target and the motion mode, receiving the image information and the sensor information around the operation target, and generating the presentation image based on the image information and the sensor information. The processing circuit may be dedicated hardware, or may also be a processor (also referred to as a central processing unit (CPU), a processing device, an arithmetic device, a microprocessor, a microcomputer, or a digital signal processor (DSP)) executing a program stored in a memory.

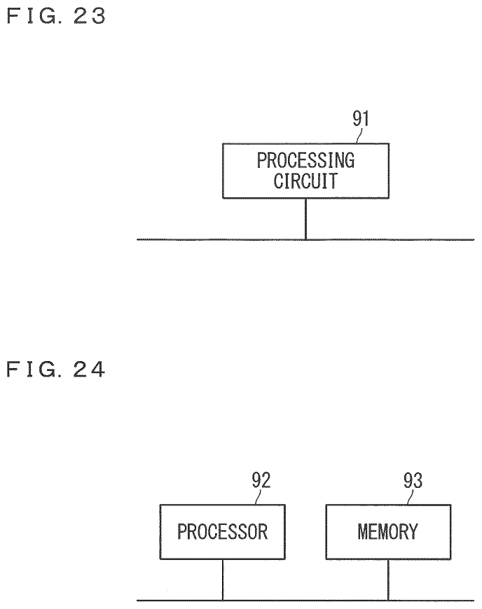

When the processing circuit is the dedicated hardware, a single circuit, a complex circuit, a programmed processor, a parallel-programmed processor, an application specific integrated circuit (ASIC), a field-programmable gate array (FPGA), or a combination of them, for example, falls under a processing circuit 91 as illustrated in FIG. 23. Each function of the operation amount acquisition unit 61, the setting unit 62, the transmission unit 63, the receiving unit 64, and the image generation unit 65 may be achieved by the processing circuit 91, or each function may be collectively achieved by one processing circuit 91.

When the processing circuit 91 is a processor 92 illustrated in FIG. 24, each function of the operation amount acquisition unit 61, the setting unit 62, the transmission unit 63, the receiving unit 64, and the image generation unit 65 is achieved by software, firmware, or a combination of software and firmware. The software or the firmware is described as a program and is stored in a memory 93. The processor 92 reads out and executes a program stored in the memory 93, thereby achieving each function. That is to say, the moving body remote operation apparatus 6 includes the memory 93 for storing a program to resultingly execute steps of: acquiring the operation amount, setting the operation target and the motion mode, transmitting the operation target and the motion mode, receiving the image information and the sensor information around the operation target, and generating the presentation image based on the image information and the sensor information. These programs are also deemed to make a computer execute procedures or methods of the operation amount acquisition unit 61, the setting unit 62, the transmission unit 63, the receiving unit 64, and the image generation unit 65. Herein, a memory may be a non-volatile or volatile semiconductor memory such as a Random Access Memory (RAM), a Read Only Memory (ROM), a flash memory, an Electrically Programmable Read Only Memory (EPROM), or an Electrically Erasable Programmable Read Only Memory (EEPROM), a magnetic disc, a flexible disc, an optical disc, a compact disc, a Digital Versatile Disc (DVD), or any storage medium which is to be used in the future.

It is also applicable that some of the functions of the operation amount acquisition unit 61, the setting unit 62, the transmission unit 63, the receiving unit 64, and the image generation unit 65 are achieved by dedicated hardware, and other functions are achieved by software or firmware.

As described above, the processing circuit can achieve each function described above by the hardware, the software, the firmware, or the combination of them, for example.

The hardware configuration of the moving body remote operation apparatus 6 illustrated in FIG. 4 is described above. The same applies to the hardware configuration of each of the moving body control apparatus 7 illustrated in FIG. 5, the moving body remote operation apparatus 6 illustrated in FIG. 21, and the moving body control apparatus 7 illustrated in FIG. 22.

Each embodiment can be arbitrarily combined, or each embodiment can be appropriately varied or omitted within the scope of the disclosure.

Although the present disclosure is described in detail, the foregoing description is in all aspects illustrative and does not restrict the disclosure. It is therefore understood that numerous modification examples not illustrated can be devised.

### EXPLANATION OF REFERENCE SIGNS

1 operation system, 2 first moving body system, 3 second moving body system, 4 third moving body system, 5 network, 6 moving body remote operation apparatus, 7 moving body control apparatus, 8 moving body, 11 moving body remote operation apparatus, 12 operation apparatus, 13 image display, 14 operator, 15 joystick, 16 touch panel, 21 moving body control apparatus, 22 first moving body, 31 moving body control apparatus, 32 second moving body, 41 moving body control apparatus, 42 third moving body, 61 operation amount acquisition unit, 62 setting unit, 63 transmission unit, 64 receiving unit, 65 image generation unit, 71 receiving unit, 72 control amount calculation unit, 73 control amount adjustment unit, 74 image acquisition unit, 75 sensor acquisition unit, 76 transmission unit, 81 movement controller, 82 camera, 83 sensor, 91 processing circuit, 92 processor, 93 memory, 721 state equation, 722 output equation, 723 flexible controller, 724 controller.

1. A moving body remote operation system, comprising:
a processor to execute a program, and
a memory to store the program which, when executed by the processor, performs processes of,
acquiring an operation amount from an operation apparatus operated by an operator;
setting an operation target in a plurality of moving bodies performing motions in different movement models; and
calculating a control amount of controlling the operation target which has been set based on the operation amount which has been acquired.

2. A moving body remote operation apparatus, comprising:
a processor to execute a program, and
a memory to store the program which, when executed by the processor, performs processes of,
acquiring an operation amount from an operation apparatus operated by an operator;
setting an operation target in a plurality of moving bodies performing motions in different movement models; and
transmitting the operation amount which has been acquired to a moving body control apparatus controlling the operation target.

3. The moving body remote operation apparatus according to claim 2, wherein
set is a motion mode as a movement model of making the operation target designated by the operator perform a motion, and
transmitted is the motion mode to the moving body control apparatus.

4. The moving body remote operation apparatus according to claim 2, further comprising:
receiving image information and sensor information around the operation target from the moving body control apparatus; and
generating a presentation image presented to the operator based on the image information and the sensor information which has been received.

5. The moving body remote operation apparatus according to claim 4, wherein
corrected is the presentation image to prevent a time delay in accordance with control of the operation target.

6. The moving body remote operation apparatus according to claim 4, wherein
when the operator performs an operation of rotation, corrected is the presentation image so that the operation target is rotated in place by changing a viewpoint in accordance with a movement of the operation target.

7. The moving body remote operation apparatus according to claim 4, further comprising:
calculating a control amount of controlling the operation target based on the operation amount which has been acquired; and
adjusting the control amount in accordance with a scale of the operation target.

8. The moving body remote operation apparatus according to claim 3, wherein
when the operation target designated by the operator is set, the motion mode is automatically selected.

9. The moving body remote operation apparatus according to claim 2, wherein
the moving body is located in a virtual space.

10. The moving body remote operation apparatus according to claim 4, wherein
corrected is a field angle and a size of the presentation image so that a viewpoint corresponding to a movement of each the operation target is unified.

11. The moving body remote operation apparatus according to claim 4, wherein
corrected is distortion of the presentation image by a rolling movement, a pitch movement, and an up-down movement of the operation target.

12. The moving body remote operation apparatus according to claim 4, wherein
received is a control amount of controlling the operation target calculated based on the operation amount from the moving body control apparatus, and
generated is the presentation image including the control amount.

13. The moving body remote operation apparatus according to claim 4, wherein
when a movement model corresponding to a motion of an operation of the operation apparatus and a movement model of the operation target are different from each other, generated is the presentation image including an image simulating another operation apparatus corresponding to a movement model of the operation target.

14. The moving body remote operation apparatus according to claim 13, wherein
converted is the operation amount acquired from the operation apparatus into an operation amount in the another operation apparatus.

15. A moving body control apparatus, comprising:
a processor to execute a program, and
a memory to store the program which, when executed by the processor, performs processes of,
receiving the operation amount transmitted from the moving body remote operation apparatus according to claim 2; and
calculating a control amount of controlling the operation target based on the operation amount which has been received by the receiving unit.

16. The moving body control apparatus according to claim 15, further comprising:
acquiring image information around the operation target from a camera provided to the operation target;
acquiring sensor information regarding a movement of the operation target from a sensor provided to the operation target; and
transmitting the image information which has been acquired and the sensor information which has been acquired to the moving body remote operation apparatus.

17. The moving body control apparatus according to claim 15, wherein
received is a motion mode transmitted from the moving body remote operation apparatus as a movement model of making the operation target designated by the operator perform a motion, and
calculated is the control amount of making the operation target simulate a motion corresponding to the motion mode.

18. The moving body control apparatus according to claim 15, further comprising
adjusting the control amount which has been calculated in accordance with a scale of the operation target.
